(19) United States
(12) Patent Application Publication
(10) Pub. No.: US 2007/0269582 A1
(43) Pub. Date: Nov. 22, 2007

(54) Pastrami sausage and method for making same

(76) Inventor: Philip R. Carter, New York, NY (US)

Correspondence Address: COOPER & DUNHAM, LLP, 1185 AVENUE OF THE AMERICAS, NEW YORK, NY, 10036, US

(21) Appl. No.: 11/437,204

(22) Filed: May 19, 2006

(51) Int. Cl. A23L 1/31

(52) U.S. Cl. 426/646

(57) ABSTRACT

The invention provides a method for making a pastrami sausage comprising providing a meatcut for use in making pastrami, during the meat cut in a salt spice mixture comprising salt, pepper and one or more of cloves, sugar, garlic, bay leaves, onion, paprika, mayoram, mace, mustard seeds, juniper berries, coriander, and ginger for about one to three weeks, smoking the meat over low heat for from about four to about six hours to import a smoked flavor to the meat, grinding the cured and smoked meat to produce a ground meat product; and filling a sausage casing with the ground meat product.

### FIELD OF THE INVENTION

This invention relates to improved methods of making pastrami, and to products made according to such improved methods.

### BACKGROUND OF THE INVENTION

Pastrami has had many cured meat devotees since its introduction to the United States by Eastern European immigrants in the late 19^{th} century in delicatessens located in the Lower East Side of New York City. Originally developed in Eastern Europe, principally Romania, as a way of preserving meat before the widespread availability of refrigeration, freezing, and other methods of food preservation, it involved pickling a piece of beef, usually a brisket or the fattier part behind the brisket, known as the plate. The meat was rubbed with a mixture of salt and spices, mainly coriander, pepper, juniper berries, garlic, and saltpeter, and the meat was dry cured in barrels for about three weeks. Corned beef, a close cousin of pastrami, also originated from the need to preserve meat before refrigeration, using a brine solution including pickling spices, in which the meat would be soaked for several weeks.

Various recipes have survived from the delicatessens and restaurants started by Eastern European immigrants, and in some cases they remain closely guarded secrets. Nevertheless, a number of good recipes exist, and good authentic pastrami can be obtained at a number of restaurants and delis in New York City.

There are those New Yorkers who believe that good pastrami does not travel well, and that it is particularly difficult to get a good authentic pastrami (or corned beef) sandwich outside New York City, despite the availability of such modern preservation methods as vacuum packaging, refrigeration, and freezing. While others dismiss such a position as boastful and unfounded, or even chauvinistic, there is a need to provide pastrami in a form which can be packaged and shipped without loosing its unique flavor and piquancy.

### SUMMARY OF THE INVENTION

It is therefore an object of the invention to provide an improved method of manufacturing and packaging cured meat, such as pastrami, that preserves its flavor and spiciness, despite packaging and storage.

The foregoing disadvantages have been overcome by providing, in one embodiment, a method for manufacturing sausages made of fresh pastrami. The method comprises providing a cut of meat for use in making pastrami, curing the cut of meat with a salt and spice mixture for a period of time sufficient to allow the salt and spice mixture to be absorbed into the exterior and interior of the cut of meat; smoking the meat cut over slowly burning wood for a period of time sufficient to impart a smoked flavor to the meat; removing the meat from the smoker after completion of smoking; and grinding the meat to form a ground meat mixture and inserting the ground meat mixture into a casing to form a pastrami sausage. The invention also provides the convenience and easy handling of a sausage, knockwurst, salami, or frankfurter shaped food item made in accordance with the foregoing method, and having the taste of cooked pastrami.

### BRIEF DESCRIPTION OF THE DRAWINGS

Further features and advantages of the invention may be understood by reference to the following detailed description of the preferred embodiments, taken in connection with the appended drawings, in which:

FIG. 1 is a flow chart of the process for making, the pastrami sausage, knockwurst, or frankfurter of the present invention; and

FIG. 2 is a schematic diagram of a machine that grinds the pastrami and stuffs the ground meat into a casing.

FIG. 3 is a schematic diagram of a sausage filling machine.

FIG. 4 is a fragmentary side view in partial cross-section of the spout of the sausage filler of FIG. 3 shown filling a casing.

### DETAILED DESCRIPTION OF THE PREFERRED EMBODIMENTS

Pastrami is traditionally made from the forequarter of the animal, from a cut known as the deckle or plate, but may be made from brisket as well. Like corned beef, the meat is first cured, but unlike corned beef, the meat is usually dry cured in a paste of seasoned salt, then smoked and steamed. Some pastrami is brined, not dry cured, and it is sometimes simmered in boiling water rather than steamed. According to some recipes, if the meat has been hot smoked long enough, it need not be cooked further.

Corned beef and pastrami were both first created as a way to preserved meat by using salt, which is reflected in their names: “corned” refers to the large grains of salt used to make the brine, and the word pastrami derives from the Romanian word pastra, which means “to preserve.”As meat, a large number of meat types and cuts can be used to make pastrami. While beef brisket, or plate, the fattier part behind the brisket, known as the plate or deckle, is preferred, a large number of other cuts of beef can be used, such as chuck, round, shoulder roast and the like. Other types of meat and game can also be used, including can light or dark turkey meat, duck, veal, chicken, mutton, lamb, ham or pork cut. In addition, bison, elk, venison or other similar types of wild or domesticated animals can be used, as can various types of fleshy, meaty fish can also be used, including tuna, salmon, or other fish. Thus the term “meat,” as used herein, includes the foregoing cuts of meat, fish, and other suitable cuts of meat or fish that a person of ordinary skill could use to make pastrami. Alternatively, for those seeking to make a meatless or vegetarian product, tofu, or similar plant based protein source can also be used.

The spices used in preparing the pastrami sausages of the present invention include the spices conventionally used to make pastrami, such as coriander, pepper, mustard seeds, ginger, garlic, juniper berries, onion, paprika, marjoram, mace, white pepper, brown sugar, white sugar, bay leaves (whole or crumpled), and cloves. The particular choice of spices, the combination and amounts thereof, are a matter of taste, and can be worked out by a person of ordinary skill in the art.

The spices are combined with salt, either as a dry paste rubbed on the surface of the meat, or mixed with a brine solution made by following the recipe set forth below, omitting the water. The dry meat coated with the salt-spice paste, is placed in a plastic bag or other sealable container, and kept in a cool, dark place for from seven days to about three weeks.

One example of a spice mixture for use in practicing the present invention:

| | |
|---|---|
| 2 tbsp. black peppercorns | 2 tsp. whole juniper berries, |
| 1 tbsp. plus 2 teaspoons dried | plus ⅓ cup crushed juniper |
| thyme | berries |
| 6 bay leaves, crumpled | 6 cups water |
| 2 tsp. whole cloves | ¾ cup kosher salt |
| ¼ cup minced garlic | ¾ cup light brown sugar |
| | ⅔ cup coarsely ground black |
| | pepper |

This spice mixture is given in small quantities, which can be increased for larger batches, if the ratios are kept approximately the same. In a mixing bowl, combine the peppercorns, thyme, bay leaves, cloves, garlic, and whole juniper berries. In a saucepan, over medium heat, combine the water, brown sugar, and salt. Bring to a boil and stir to dissolve the sugar and salt. Remove from the heat and add dry spice mixture and steep for about 1 hour. Place a 4 to 5 pound brisket in a glass or plastic container. Pour the seasoned brine to cover the brisket completely. Cover and refrigerate for 3 weeks, turning the brisket every couple of days.

Remove the brisket from the marinade and discard the marinade. Pat the meat dry. Combine the remaining ⅓ cup of the crushed juniper berries and the remaining black pepper in a small bowl. Rub the meat with the berry and pepper mixture, and press the mixture into the surface of the meat on all sides.

The next step involves smoking the meat following the curing step, either wet or dry, discussed above. Preheat the smoker before placing the meat inside. The meat should be smoked for a period of hours, such as four to eight or more hours, or overnight in a smoker or smoking room. The meat can be placed in a commercial smoker, or hung using kitchen twine or a metal hook over a slowly burning fire of wood chips, or charcoal soaked in or moistened with water, such as hickory, apple or other fruitwood, mesquite, oak, cedar or other wood, or a combination of any of the foregoing, according to the directions of the manufacturer of the smoker. The wood used should not produce an acrid smoke, as that may impart a bitter flavor to the pastrami. The meat should be smoked in the smoker or in a smokehouse at very low heat, for four to six or more hours.

After smoking, the meat should be cooled. Usually, to prepare it for eating, it is heated in a closed pot with boiling water or stock to steam it until heated through, and it is moist and tender. Such steaming, however, is unnecessary to prepare pastrami sausages in accordance with the present invention, since they will be steamed, boiled, or broiled before eating by the consumer.

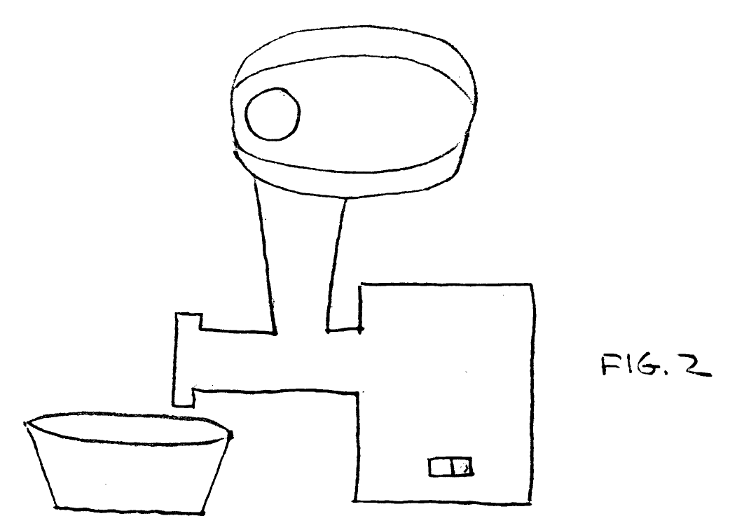

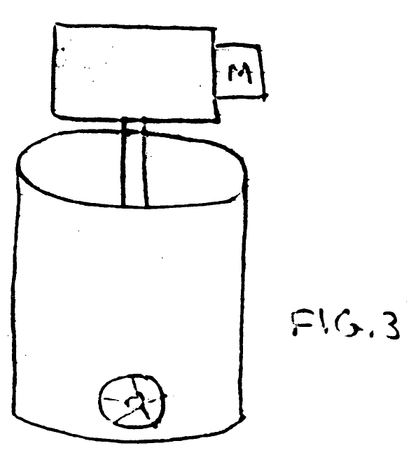

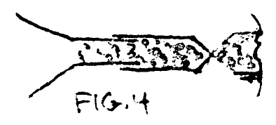

The pastrami should now be ground and extruded into a sausage casing as shown in FIG. 2. A grinder with a sausage filling adapter, either electrically driven or hand cranked, can be used. For example, a KitchenAid mixer has a meat grinder attachment that can be fitted with a sausage stuffer to make smaller batches. Larger industrial sized machines, made by Hobart or other manufacturers, and well known to those skilled in the art, can be used to make larger batches of ground pastrami meat, as shown in FIGS. 2-4. The process can also be adapted to commercial scale.

### EXAMPLE 1

### Preparation of Pastrami

5-6 lbs. beef silverside, deckle, brisket, plate or other cut of beef, trimmed of excess fat

4 ounces canning or kosher salt

1 ounce cracked black pepper

2 ounces light or dark brown sugar

2 ounces fresh ginger, peeled and minced

1 ounce fresh garlic, crushed

1 ounce ground coriander

Additional cracked black pepper

White beef stock

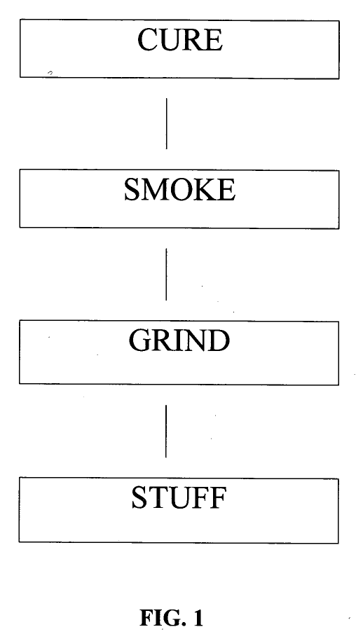

The steps involved in preparation are set forth in FIG. 1. Combine the salt, pepper, sugar, ginger, garlic, and coriander. Working on a clean, nonporous surface, rub the seasoning mixture into all surfaces of the beef. Place the beef with all the seasonings into a heavy-duty sealable plastic bag. Expel the excess air, and carefully tie and seal the bag. Put the bag in the cooler. Rotate and lightly massage the sealed bag at least once a day for 12 days. Remove the meat from the bag.

Preheat a smoker to 65° F. (18° C.). Adjust the dampers to wide open. Remove the beef from the plastic bag. Using a trussing needle and strong cord, provide a secure loop to hang the meat on a smoke stick. Place the meat into the smoker. Allow to air dry with no smoke for a full 24 hours. Remove the meat from the smoker and cover loosely. Set the temperature at 130° F. (54° C.) with the dampers wide open. Return the meat to the smoker and hold at this setting for 2 hours. Adjust the dampers to one-half open. Monitor the temperature and raise the temperature gradually over the next several hours. Remove the pastrami when its internal temperature reaches 120° F. (49° C.). Do not shower with cold water. Apply a finishing rub of cracked pepper. Cool quickly and wrap tightly. Refrigerate for 2 days before using. Store the pastrami tightly wrapped and well-chilled at all times.

### EXAMPLE 2

### Preparation of Pastrami Sausage

The smoked but uncooked pastrami made in accordance with Example 1 is placed in a meat grinder and coarsely ground. The ground pastrami is then fed into a sausage filling machine, and fed into natural or artificial sausage casings. A meat grinder fitted with a sausage filler at its opening may also be used, such as shown in FIG. 2. The stuffed pastrami sausages may be quickly frozen, or steamed and then quickly frozen, and can be smoked again. Alternatively, they may be refrigerated for use or sale as a fresh meat item, which can be prepared for eating by simmering in water or stock. They can also be grilled like a hot dog, placed on caraway seeded or unseeded rye frankfurter bun and topped with coleslaw.

### EXAMPLE 3

### Preparation of Turkey Pastrami Sausage

Five to six pounds of boneless whole turkey breast in one or two pieces is substituted for the beef cut used in Example 1. The recipe is followed as above, yielding turkey pastrami, which is ground and fed into sausage casings, as set forth in Example 2.

### EXAMPLE 4

### Preparation of Salmon Pastrami Sausage

Six pounds of fresh, boneless salmon filet in one or two pieces is substituted for the beef cut used in Example 1. The recipe is followed as above, yielding salmon pastrami, which is ground and fed into sausage casings, as set forth in Example 2.

### EXAMPLE 5

### Preparation of Tuna Pastrami Sausage

Six pounds of fresh, boneless tuna filet in one or two pieces is substituted for the beef cut used in Example 1. The recipe is followed as above, yielding tuna pastrami, which is ground and fed into sausage casings, as set forth in Example 2.

### EXAMPLE 6

### Preparation of Duck Breast Pastrami Sausage

Six pounds of fresh, boneless duck breast (or a combination of duck breast and other duck meat) in one or two pieces is substituted for the beef cut used in Example 1. The recipe is followed as above, yielding tuna pastrami, which is ground and fed into sausage casings, as set forth in Example 2.

### EXAMPLE 7

### Preparation of Corned Beef Sausage

Six pounds of fresh beef brisket, dechle or plate, is soaked in brine solution (made from about one cup of coarse or kosher salt in four cups of water) for about two to three weeks in a covered container in a refrigerated or cool, dry place. The meat is turned every day or two, and kept submerged in the brine.

When brining is completed, the corned beef is removed from the brine solution, then ground and stuffed into sausage casings without smoking. The sausages may be frozen if desired or kept under refrigeration. To serve, they should be simmered in water, or grilled like a frankfurter.

The examples set forth above are meant to be illustrative of the practice of the invention, and not limiting. It is intended that the following claims, read in light of the specifications, define the invention.

I claim:

1. A method for making pastrami sausage comprising:
providing a meat cut for use in making pastrami;
curing the meat cut in a salt spice mixture comprising salt, pepper and one or more of cloves, sugar, garlic, bay leaves, onion, paprika, marjoram, mace, mustard seeds, juniper berries, coriander, and ginger for about one to three weeks;
smoking the meat over low heat for from about four to about six hours to import a smoked flavor to the meat cut;
grinding the cured and smoked meat cut to produce a ground meat product; and
filling a sausage casing with the ground meat product.

2. A method according to claim 1, wherein the meat cut is beef, brisket, deckle, plate, round, or chuck.

3. A method according to claim 1, wherein the meat cut is from, tuna, salmon or another fish.

4. A method according to claim 1, wherein the meat cut is veal, lamb, turkey, duck goose, elk, bison, venison, ham or pork cut.

5. A method according to claim 2, wherein the salt spice mixture is dry and rubbed on the surface of the meat cut.

6. A method according to claim 2, wherein the salt spice mixture is a brine solution, and the meat cut is cured by soaking the meat cut in the brine solution.

7. A method according to claim 5, wherein the smoking step is carried out over a slowly burning fire of wood, woodchips, or charcoal, moistened with or soaked in water.

8. A method according to claim 7 wherein the wood, wood chips, or charcoal contain oak, mesquite, apple, hickory, or cedar.

9. A pastrami sausage made in accordance with the method of claim 2.

10. A pastrami sausage made in accordance with the method of claim 3.

11. A pastrami sausage made in accordance with the method of claim 4.

12. A pastrami sausage made in accordance with the method of claim 5.

13. A method for making a corned beef sausage, comprising:
providing a cut of beef, soaking the cut of beef in a brine solution in a closed container for a period of about two to three week to make corned beef, removing the corned beef from the brine solution, grinding the corned beef to obtain ground corned beef and stuffing the ground corned beef into one or more sausage casings to form the corned beef sausage.
